(19) United States
(12) Patent Application Publication
(10) Pub. No.: US 2008/0244940 A1
(43) Pub. Date: Oct. 9, 2008

(54) Periodic messaging system

(76) Inventor: Yigal Mesika, Los Angeles, CA (US)

Correspondence Address: Yigal Mesika, 7245 Hillside Avenue #310, Los Angeles, CA, 90046, US

(21) Appl. No.: 11/732,661

(22) Filed: Apr. 4, 2007

(51) Int. Cl. G09F 13/12

(52) U.S. Cl. 40/219

(57) ABSTRACT

A periodic messaging system is described. The messaging system includes a mirror having a front side and a back side, with the front side being reflective. A message device is attached with the back side of the mirror and is configured to display a periodic, illuminated message. The mirror includes a transparent portion and the message device is attached with the back side of the mirror such that the periodic, illuminated message is displayed toward the transparent portion. Thus, when the message is illuminated, the message is viewable from the front side of the mirror, whereby through use of the message device, a user can present periodic messages to viewers using a mirror.

### BACKGROUND OF THE INVENTION

(1) Field of Invention

The present invention relates to a messaging system, and more particularly to a messaging system that periodically displays the message to a viewer to create a periodic or subliminal message affect.

(2) Description of Related Art

Periodic messages are often used to alert a viewer or otherwise draw their attention. For example, flashing lights, by their periodic nature, cause viewers to take notice of the flashing light. When applied to marketing or other advertising media, a flashing message (periodic message) gains the attention of the viewer, thereby causing them to take notice of the advertised message.

In the past, marketers have altered the concept of periodic messaging to create what is known as a subliminal message. A subliminal message is a signal or message embedded in another object, designed to pass below the normal limits of perception. These messages are typically indiscernible to the conscious mind, but are alleged to be perceptible to the subconscious or deeper mind: for example, an image transmitted so briefly that it is only perceived subconsciously, but not otherwise noticed.

Subliminal messages are typically embedded in an audio/visual broadcast and/or presentation. For example, in the 1950's, movies were produced that flashed the slogans “Eat Popcorn” and “Drink Coca Cola.” The idea behind such messages is that they subconsciously influence the viewer to purchase popcorn and Coca Cola, respectively.

While used in audio/visual presentations for mass media, such subliminal messages and/or periodic messages have not been incorporated into mediums that are commonly available and utilized on an individual basis, such as a mirror.

Thus, a continuing need exists for a periodic messaging system that can be utilized in a multitude of locations, yet be focused on an individual.

### SUMMARY OF INVENTION

The present invention relates to periodic messaging system. The messaging system includes a mirror having a front side and a back side, with the front side being reflective. A message device is attached with the back side of the mirror and is configured to display a periodic, illuminated message. The mirror includes a transparent portion and the message device is attached with the back side of the mirror such that the periodic, illuminated message is displayed toward the transparent portion. Thus, when the message is illuminated, the message is viewable from the front side of the mirror, whereby through use of the message device, a user can present periodic messages to viewers using a mirror.

In another aspect, the back side of the mirror surrounding the transparent portion is covered with an opaque material.

In yet another aspect, the message device is formed to display a single, periodic illuminated message, with the message having a size and shape. Additionally, the transparent portion is formed to correspond with the size and shape of the message.

In yet another aspect, the message device is configured to display the illuminated message for a limited amount of time so that the message is only perceived subconsciously.

In another aspect, the message device is configured to display the illuminated message periodically for a sufficient amount of time so that the message can be perceived consciously.

In yet another aspect, the message device is programmable to enable a user to alter the message as desired, with the transparent portion being formed to accommodate multiple messages.

In another aspect, the messaging system further comprises a sensor attached with the message device so that the message is displayed when a user is present.

Finally, as can be appreciated by one in the art, the present invention also comprises a method for forming and using the messaging system described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration of a periodic messaging system according to the present invention;

FIG. 2 is a side-view illustration of the periodic messaging system according to the present invention; and

FIG. 3 is a front-view illustration of the periodic messaging system according to the present invention.

### DETAILED DESCRIPTION

The present invention relates to a messaging system, and more particularly to a messaging system that periodically displays the message to a viewer to create a periodic or subliminal message affect. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

(1) Description

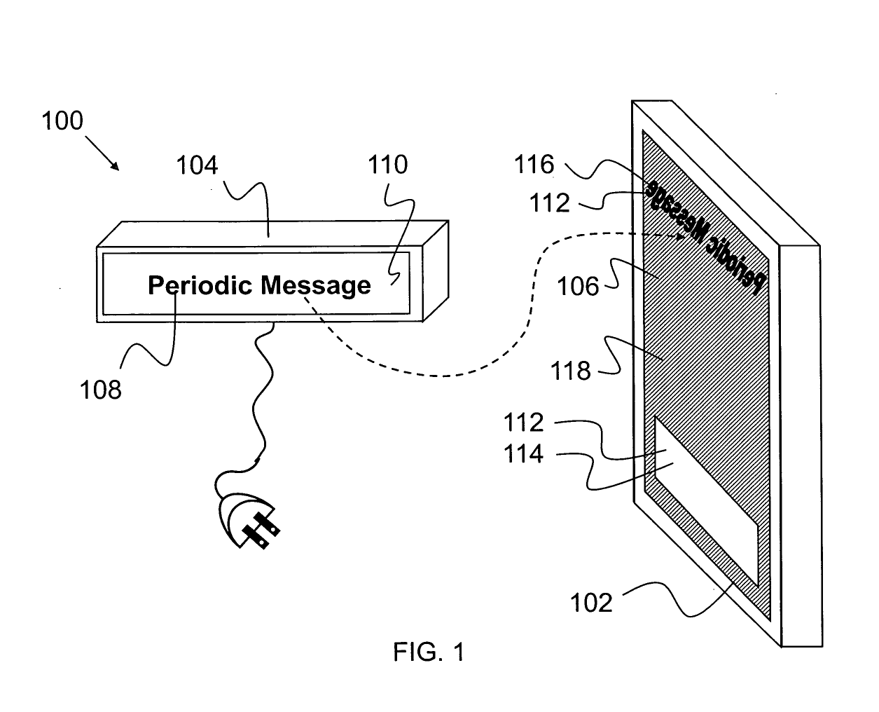

The present invention relates to a periodic messaging system. As shown in FIG. 1, the messaging system 100 includes a mirror 102 and a message device 104. The mirror 102 has a front side (shown as element 300 in FIG. 3) and a back side 106. As can be appreciated by one skilled in the art, the front side is reflective, thereby operating as a looking glass (e.g., standard mirror) to allow user's to view their reflection in the mirror. However, as described in further detail below, the mirror 102 also operates as a one way mirror to allow a message to be displayed therethrough.

To operate as a messaging system 100, the present invention includes the message device 104. The message device 104 is attached with the back side 106 of the mirror 102 and is configured to display a periodic, illuminated message 108. Thus, the message device 104 includes a light mechanism that can be actuated to display the message 108 on a surface 110 of the message device 104.

To allow the message 108 to be viewable from the front side of the mirror 102, the mirror 102 includes a transparent portion 112. The message device 104 is attached with the back side 106 of the mirror 102 such that the message 108 is displayed toward the transparent portion 112. Therefore, when the message 108 is illuminated by the message device 104, the message 108 is viewable through, and from the front side of the mirror 102.

As can be appreciated by one skilled in the art, the message device 104 can be formed so that it is programmable, thereby enabling a user to alter the message 108 as desired. Such programmable messaging systems are commonly known in the art, a non-limiting example of which includes light emitting diode (L.E.D.) message boards.

When the message device 104 is programmable, it is important that the transparent portion 112 be able to accommodate a large variety of letters and messages. Thus, the transparent portion 112 is formed in any suitable shape to accommodate multiple messages. As a non-limiting example, the transparent portion 112 can be formed as a rectangular region 114 that provides a transparency to the mirror 102 to accommodate any message 108 displayed by the message device 104.

In another aspect, the message device 104 is formed to display a single, periodic illuminated message 108. For example, the message 108 may be related to a particular product or service. In order to be viewable from the front side, the message 108 must be positioned proximate the transparent portion 112. As with multiple messages, the transparent portion 112 can be formed in any suitable shape as long as it provides a transparent pathway through the mirror 102 for the message 108 to be viewable from the front side. As a non-limiting example, the message 108 has a particular size and shape and the transparent portion 112 is formed to correspond directly with the size and shape of the message 108. Thus, in this aspect, the transparent portion 112 is a message-specific transparent portion 116.

Using a one-way mirror, it is possible that the transparent portion 112 encompasses the entire mirror 102. Such a configuration works if it is generally dark behind the mirror 102 (with the exception of the message 108). In another aspect, the messaging system 100 can be formed such that only a portion of the mirror 102 is transparent. In contrast with the transparent portion 112, the back side 106 of the mirror 102 surrounding the transparent portion 112 can be covered with an opaque material 118. The opaque material 118 is any suitable material for blocking the passage of light, a non-limiting example of which includes black paint.

As can be appreciated by one skilled in the art, the message device 104 includes electronic components and delay circuitry for displaying the message 108 in a periodic fashion. For example, the message device 104 can be configured to display the illuminated message 108 for a very limited amount of time so that the message 108 is perceived subconsciously. More specifically, the message 108 can be displayed so that it is only visible between 1/1000^{th} and ½ of a second. Thus, the messaging system 100 operates as a subliminal messaging system.

In another aspect, the message device 104 can be configured to display the illuminated message periodically for a sufficient amount of time so that the message 108 is perceived consciously. As a non-limiting example, the message 108 can be displayed for an amount of time between 1/10^{th} of a second and several seconds. In this aspect, a user would consciously see the message 108 as a periodically flashing message.

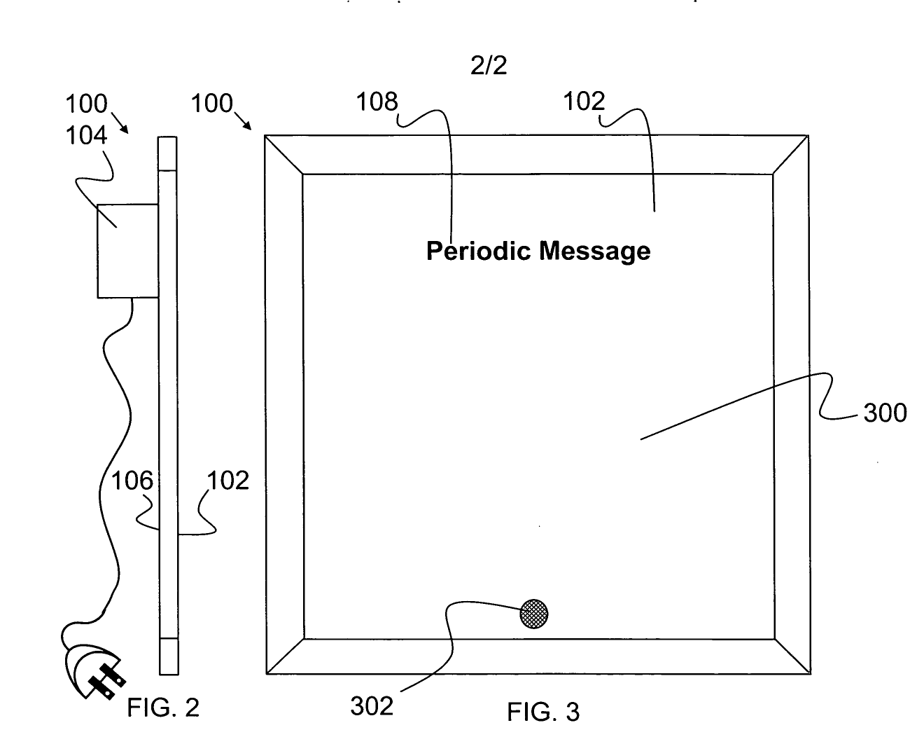

FIG. 2 illustrates a side view of the messaging system 100. As shown, the message device 104 is attached with the back side 106 of the mirror 102. Therefore, as shown in FIG. 3, the message 108 is viewable by a user at a front side 300 of the mirror 102.

In another aspect, a sensor 302 can be attached with the messaging system 100 and the message device so that the message 108 is displayed when a user is present. The sensor 302 is any suitable sensor capable of sensing a user, non-limiting examples of which include a motion and light sensor. In this aspect, when a user attempts to use the mirror 102, the sensor 302 actuates the message device to display the message 108 on the front side 300 of the mirror 102. Thus, a user is provided with the message 108 upon approaching the mirror.

What is claimed is:

1. A periodic messaging system, comprising:
a mirror having a front side and a back side, the front side being reflective;
a message device attached with the back side of the mirror and configured to display a periodic, illuminated message; and
wherein the mirror includes a transparent portion and the message device is attached with the back side of the mirror such that the periodic, illuminated message is displayed toward the transparent portion, such that when the message is illuminated, the message is viewable from the front side of the mirror, whereby through use of the message device, a user can present periodic messages to viewers using a mirror.

2. A periodic messaging system as set forth in claim 1, wherein the back side of the mirror surrounding the transparent portion is covered with an opaque material.

3. A periodic messaging system as set forth in claim 2, wherein message device is formed to display a single, periodic illuminated message, the message having a size and shape, and the transparent portion being formed to correspond with the size and shape of the message.

4. A periodic messaging system as set forth in claim 3, wherein the message device is configured to display the illuminated message for a limited amount of time so that the message is only perceived subconsciously.

5. A periodic messaging system as set forth in claim 3, wherein the message device is configured to display the illuminated message periodically for a sufficient amount of time so that the message can be perceived consciously.

6. A periodic messaging system as set forth in claim 2, wherein the message device is programmable to enable a user to alter the message as desired, with the transparent portion being formed to accommodate multiple messages.

7. A periodic messaging system as set forth in claim 6, wherein the message device is configured to display the illuminated message for a limited amount of time so that the message is only perceived subconsciously.

8. A periodic messaging system as set forth in claim 6, wherein the message device is configured to display the illuminated message periodically for a sufficient amount of time so that the message can be perceived consciously.

9. A periodic messaging system as set forth in claim 1, wherein message device is formed to display a single, periodic illuminated message, the message having a size and shape, and the transparent portion being formed to correspond with the size and shape of the message.

10. A periodic messaging system as set forth in claim 1, wherein the message device is configured to display the illuminated message for a limited amount of time so that the message is only perceived subconsciously.

11. A periodic messaging system as set forth in claim 1, wherein the message device is configured to display the illuminated message periodically for a sufficient amount of time so that the message can be perceived consciously.

12. A periodic messaging system as set forth in claim 1, wherein the message device is programmable to enable a user to alter the message as desired, with the transparent portion being formed to accommodate multiple messages.

13. A periodic messaging system as set forth in claim 1, further comprising a sensor attached with the message device so that the message is displayed when a user is present.

14. A method for forming a periodic messaging system, comprising:
forming a mirror having a front side and a back side, the front side being reflective;
attaching a message device with the back side of the mirror, the message device being configured to display a periodic, illuminated message; and
wherein in forming the mirror, the mirror includes a transparent portion and the message device is attached with the back side of the mirror such that the periodic, illuminated message is displayed toward the transparent portion, such that when the message is illuminated, the message is viewable from the front side of the mirror, whereby through use of the message device, a user can present periodic messages to viewers using a mirror.

15. A method for forming a periodic messaging system as set forth in claim 14, further comprising an act of covering the back side of the mirror surrounding the transparent portion with an opaque material.

16. A method for forming a periodic messaging system as set forth in claim 15, further comprising an act of forming the message device to display a single, periodic illuminated message, the message having a size and shape, and the transparent portion being formed to correspond with the size and shape of the message.

17. A method for forming a periodic messaging system as set forth in claim 16, further comprising an act of configuring the message device to display the illuminated message for a limited amount of time so that the message is only perceived subconsciously.

18. A method for forming a periodic messaging system as set forth in claim 16, further comprising an act of configuring the message device to display the illuminated message periodically for a sufficient amount of time so that the message can be perceived consciously.

19. A method for forming a periodic messaging system as set forth in claim 15, further comprising an act of selecting a message device such that the message device is programmable to enable a user to alter the message as desired, with the transparent portion being formed to accommodate multiple messages.

20. A method for forming a periodic messaging system as set forth in claim 19, further comprising an act of configuring the message device to display the illuminated message for a limited amount of time so that the message is only perceived subconsciously.

21. A method for forming a periodic messaging system as set forth in claim 19, further comprising an act of configuring the message device to display the illuminated message periodically for a sufficient amount of time so that the message can be perceived consciously.
